(19) United States
(12) Patent Application Publication
(10) Pub. No.: US 2002/0073035 A1
(43) Pub. Date: Jun. 13, 2002

(54) CHARING APPARATUS, A CHARGING METHOD AND A STORAGE MEDIUM

(76) Inventor: KAZUYUKI SAITO, TOKYO (JP)

Correspondence Address: FITZPATRICK CELLA HARPER & SCINTO, 30 ROCKEFELLER PLAZA, NEW YORK, NY, 10112, US

(21) Appl. No.: 09/177,485

(22) Filed: Oct. 23, 1998

(30) Foreign Application Priority Data
Oct. 27, 1997 (JP) 09-311391

(51) Int. Cl. G06F 17/60

(52) U.S. Cl. 705/52

(57) ABSTRACT

A charging apparatus that performs charging process in consideration of uses of the apparatuses related to the data processing connected with the network comprises registration unit for registering the charge information separately in accordance with the contents of processes executed by the apparatuses related to data processing, determination unit for determining a series of processed contents executed by the apparatuses related to data processing and charge processing unit for performing charging process in accordance with the charge information corresponding to the series of processed contents determined by the determination unit. With the structure thus arranged, it is possible to perform the minute and rational charging process in accordance with the rationalized charging control and management, and the contents of services rendered as well.

### BACKGROUND OF THE INVENTION

1. Field of the Invention

The present invention relates to the charge processing techniques whereby to charge fees in consideration of uses of a scanner, a printer, or some other input and output apparatuses, or a file server and other database processing apparatuses, among some others, which are connected with the network.

2. Related Background Art

Generally, the network provider charges fees to the user in consideration of his use of the apparatuses when he inputs and/or outputs documental data by the input and output apparatuses, such a scanner, a printer, and a database processing apparatus, such as a file server, which are connected with the network.

The conventional charging method is such that, for example, with the provision of a counter installed on each of the apparatuses, which counts the page numbers of the documental data that have been inputted into or output from each of them. Then, a very rough method is adopted to charge fees uniformly per page, irrespective of the contents of the documental data thus inputted or output or the like.

Also, for example, when a documental data is read by use of a scanner and the documental data thus read is output by use of a printer, there is arranged a system whereby to update the counters of both the scanner and printer.

In recent years, however, various kinds of functions have been provided for input and output apparatuses for various uses. Along with the development of a kind, the contents of service (functions and processed contents as well), which are available through the network, are diversified. The range of running costs is now very wide from the inexpensive one to the extremely expensive one.

Therefore, the conventional method, in which fees are charged uniformly per page, may impose unfairness upon users, and at the same time, a loss may be incurred on the part of the network provider if many services that have been rendered are only those requiring higher running costs, while fees are chargeable on the basis of the mean value of the running costs of the respective contents of services rendered. Under the circumstances, it is strongly demanded to perform a minute charging process in accordance with the contents of the service that has been rendered.

Also, as described above, the function is now available to update the counters of both scanner and printer. However, there is no function available to integrate the counted values of the scanner and printer. Therefore, for example, if it should be considered to implement a system whereby to make fees chargeable differently depending on each of the users, the network provider or the user should sum up the amounts of fees per user who has used both the scanner and the printer or the corresponding request of payment should be issued individually by the network provider. These additional operations are obstacles when attempting the rationalization of the charge control and management.

### SUMMARY OF THE INVENTION

With the background that has been discussed above, the present invention is designed. It is an object of the invention to make minute and rational charging process possible in accordance with the contents of services rendered.

In order to solve the problems and achieve the object of the invention described above, a charging apparatus adopted for apparatuses related to data processing connected with the network comprises registration means for registering the charge information separately in accordance with the contents of processes executed by the apparatuses related to data processing; determination means for determining a series of processed contents executed by the apparatuses related to data processing; and charge processing means for performing charging process in accordance with the charge information corresponding to the series of processed contents determined by the determination means.

Also, in consideration of uses of the apparatuses related to data processing connected with the network, a charging method for performing charging process of the present invention is arranged to comprise the steps of registering the charge information separately in accordance with the contents of processes executed by the apparatuses related to data processing; determining a series of processed contents executed by the apparatuses related to data processing; and performing charging process in accordance with the charge information corresponding to the series of processed contents determined by the determining step.

Also, in consideration of uses of the apparatuses related to data processing connected with the network, there is provided in accordance with the present invention a storage medium to store program for performing charging process, which comprises the routines of registering the charge information separately in accordance with the contents of processes executed by the apparatuses related to data processing; determining a series of processed contents executed by the apparatuses related to data processing; and performing charging process in accordance with the charge information corresponding to the series of processed contents determined by the determination routine.

Also, in accordance with the present invention, the apparatus related to data processing are a versatile computer, a scanner, a printer, a copying machine, a display device, a file server, a facsimile equipment, an external storage device, and others.

Also, in accordance with the present invention, three pieces of charging information are registered in the registering means, steps and routine described above corresponding to the three kinds of processed contents of the data input process, the data processing, and the data output process, and charging processes are performed in the charging process routine separately in accordance with the three kinds of processed contents, at the same time, the charge integration process being performed to integrate the results of charging processes in accordance with the separate processes.

Also, in accordance with the present invention, the content of the input data process is classified into the kinds, the amounts, the degrees of importance, and others with respect to the input data.

Also, the kinds of input data are classified into text data, image data, and others.

Also, the image data is classified by resolution, monochrome, and color.

Also, the contents of the data processing are classified into layout analyzing process, character recognition process, database processing, compression process, encoding process, and others.

Also, the contents of the output data process are classified into network, external storage device, facsimile equipment, file server, display device, output process to a speaker, and others.

Also, the contents of the output data process are subdivided into the sizes of paper sheet, the quality of paper, and others when output to the printer.

Other objectives and advantages besides those discussed above will be apparent to those skilled in the art from the description of a preferred embodiment of the invention which follows. In the description, reference is made to accompanying drawings, which form a part hereof, and will illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a structural view which shows the network input and output systems to which is applicable a charging apparatus embodying the present invention.

FIG. 2 is a functional block diagram which shows the detailed functions of the charging process.

FIG. 3 is a flowchart which shows the brief flow of the charging process.

FIG. 4 is a flowchart which shows the charge input process.

FIG. 5 is a flowchart which shows the execution of the charging process.

FIG. 6 is a flowchart which is a continuation of the process represented in FIG. 5.

FIG. 7 is a flowchart which shows the charge output process.

FIG. 8 is a flowchart which is a continuation of the process represented in FIG. 7.

FIG. 9 is a view which shows the contents of data on the setting table of charge points.

### DETAILED DESCRIPTION OF THE PREFERRED EMBODIMENTS

Hereinafter, with reference to the accompanying drawings, the description will be made of the embodiments in accordance with the present invention.

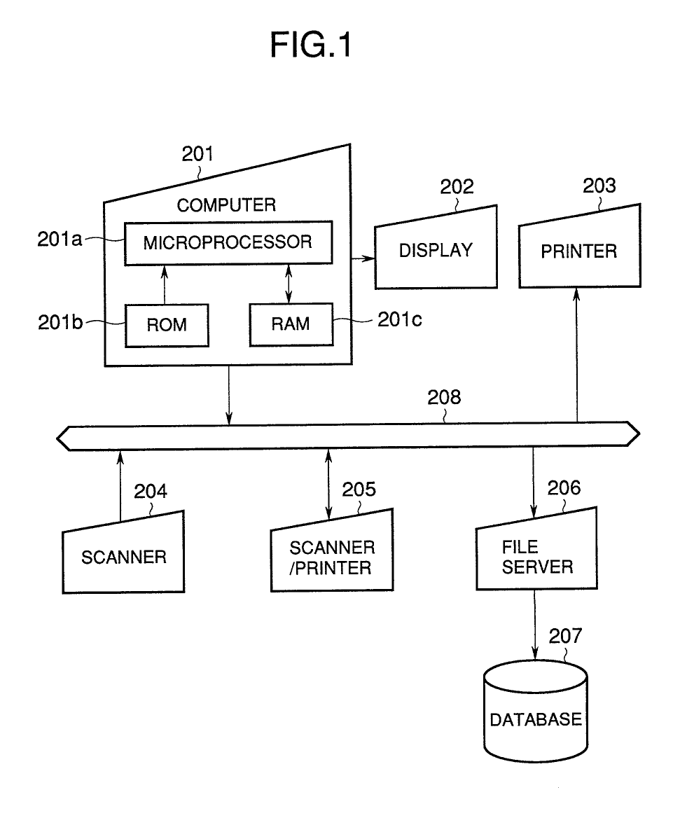

FIG. 1 is a structural view which shows the network input and output systems to which is applicable a charging apparatus embodying the present invention.

This system comprises a versatile computer 201 for executing the charging process and others by performing a layout process and the like with respect to a documental data (that is, a document); a display unit 202 that indicates the document on the screen thereof or the like; a printer 203 dedicated to the use of the print out of the document; a scanner 204 dedicated to the image input by converting the image information, which is obtained by the optical scanning of the document, into the digital electric signals; a scanner/printer 205 used for a copying machine, a facsimile equipment, or the like, that executes the image input of the document and the print output thereof complexly; a file server 206 that manages the database of documents; the database 207 that stores documents; the network 208 with which each of the digital apparatuses described above is connected, and some others.

This system is utilized in such a manner that the documental image is inputted from the scanner 204 into the computer 201, for example, and then, the character recognition is performed by the OCR to output the text code data thus obtained by the character recognition and also, to output the image data which are not prepared as text to the file server 206 after having been processed to be suitably arranged as the database or this system is utilized to encode and output the text code data to the network as the electronic mail or to input the documental data from the file server 206 into the computer 201 to reproduce the layout in accordance the layout information attached to the documental data for the output thereof by use of the printer 203.

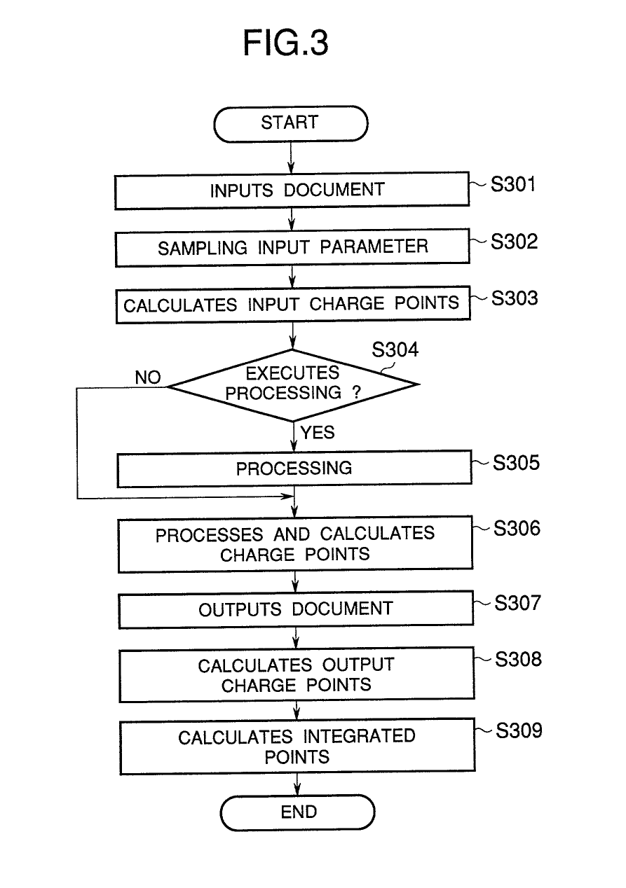

The computer 201 is provided with a microprocessor 201a, a ROM 201b, a RAM 201c. The microprocessor 201b utilizes the RAM 201c as its work area or the like and executes the document processing as described above in accordance with the various programs stored in the ROM 201b accordingly. At the same time, the microprocessor executes the charging process or the like which will be described later. Here, the programs that operate corresponding to the flowcharts shown in FIGS. 3 to 9 are also stored. These programs, however, may be provided from an external storage device, such as a floppy disc.

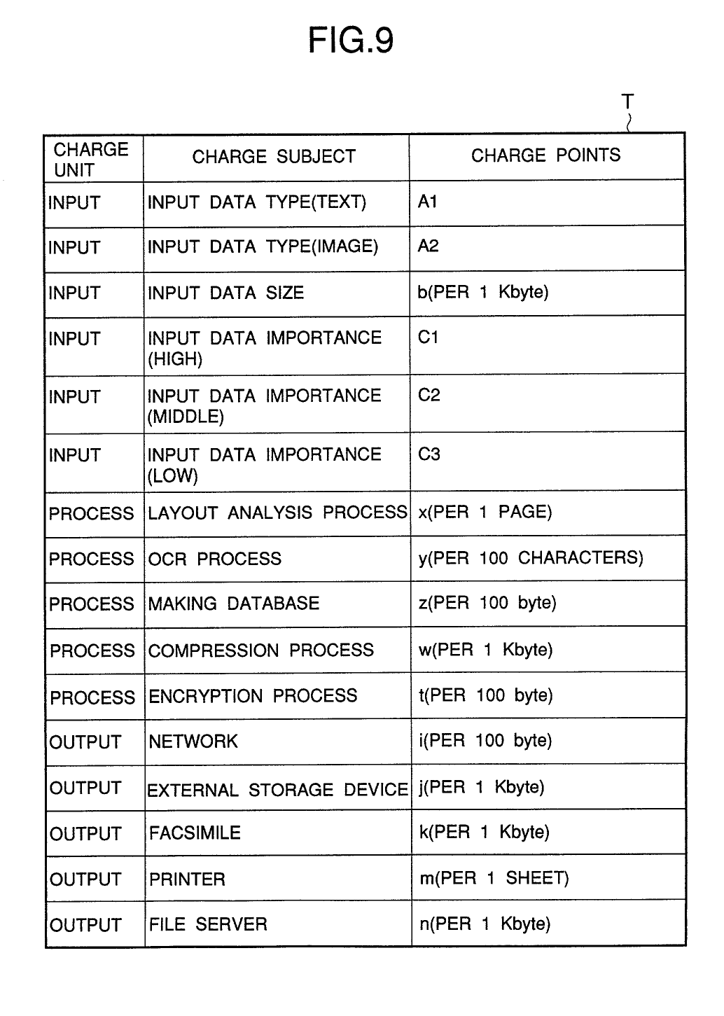

Also, the charge point setting table T as shown in FIG. 9 is formed on the RAM 201c. As shown in FIG. 9, the charge point setting table T has the charge point information listed thereon corresponding to the contents of the service rendered (that is, the parameters needed to work out the chargeable fees). The contents of the service rendered for which charges should be made are, for example, minutely classified into a plurality (here six) of charge units as to the input data. The charge point information indicates the amount that may become an update unit as one point when the actual amount of chargeable fees should be updated. If, for example, the amount of the update unit is set at 10 Yen, the amount of chargeable fees becomes 1000 Yen in a case where the value of the charge point is 100. Here, the items, Input, Process, and Output mentioned in the column of the Charge Unit in FIG. 9 are those utilized in the charge input unit 103, the charge processing unit 105, and the charge output unit 107, respectively. Then, a point of the kind is regulated not to be changed except only by a specific person who is authorized and identified by the input of his ID or password, for example. Also, it is arranged to charge the fees by the execution of the charge program using such point. Thus, any change of the charge program is prohibited except only by a specifically authorized person.

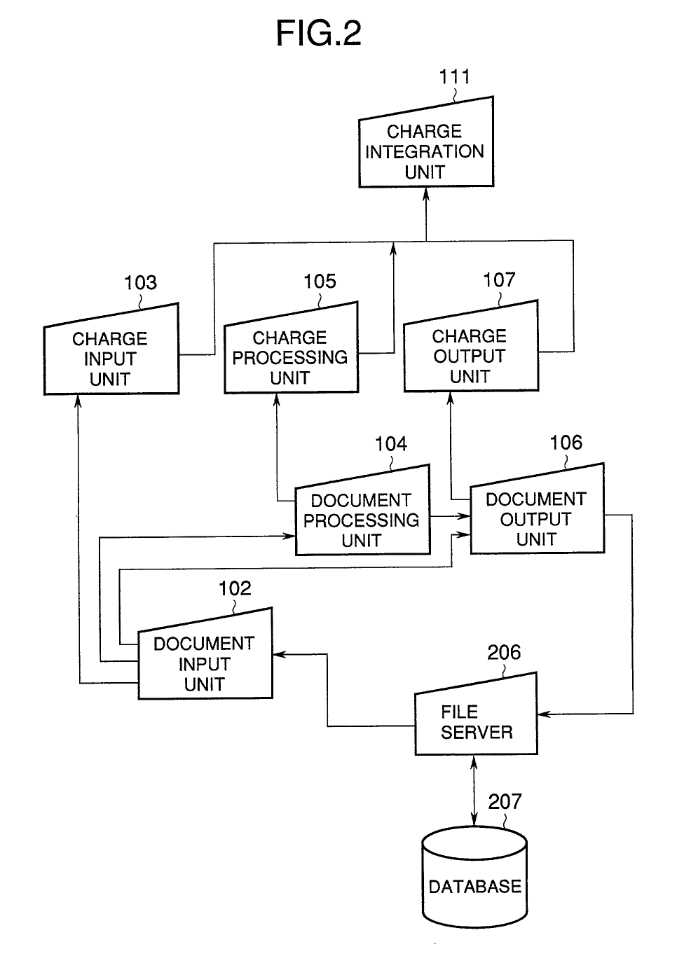

FIG. 2 is a functional block diagram which shows the detailed functions of the charging process. There are provided for the charging process, the document input unit 102 that inputs documents; the charge input unit 103 that performs charging process in accordance with the kinds of input data, the size of input data, the importance of input data and some others; the document processing unit 104 that executes the processing of documents, such as the OCR process, the database process; the charge processing unit 105 that performs charging process in accordance with the contents of document processing; the document output unit 106 that processes documents or outputs the documents yet to be processed; the charge output unit 107 that performs charging process in accordance with the kind, function, or performance of the document output unit 106; and the charge integration unit 111 that integrates the charge information obtained from the charge input unit 103, the charge processing unit 105, and the charge output unit 107.

In this respect, the document input unit 102 corresponds to the scanner 204, the scanner/printer 205, and others, as well as corresponds to the input processing unit in the computer 201. The document output unit 106 corresponds to the printer 203, the scanner/printer 205, the file server 206, the network 208, and others, as well as corresponds to the output processing unit in the computer 201. The document processing unit 104, the charge input unit 103, the charge processing unit 105, the charge output unit 107, and the charge integration unit 111 are incorporated in the computer 201. The file server 206, the database 207 in FIG. 2 are the same as those shown in FIG. 1. However, in order to facilitate understanding, the file server and database are also illustrated in FIG. 2.

Now, in accordance with the flowchart shown in FIG. 3, the brief flow of the charging process will be described.

When the document input unit 207 formed by the scanners 204 and 205, the file server 207, and others inputs documental data (step S301), the charge parameters at the time of input, that is, the kind of input data (text or image), the size of input data, the importance of input data (high, middle, or low), are output to the charge input unit 103 (step S302). Then, the charge input unit 103 retrieves from the charge point setting table T the charge point information corresponding to the charge parameters thus inputted from the document input unit 102. On the basis of the charge point information thus retrieved and the amount of input data, the charge input unit calculates the charge points per parameter, and then, calculates the total value thereof as the charge input point, which is output to the charge integration unit 111 (step S303).

For example, the scanner 204 or 205 inputs a documental image data, and if each of the charge parameters given from the document input unit 102 should be the “image data” as the kind of input data; “2000 Kilobytes” as the size of input data; the “high” as the importance of input data, the charge point will be A2 as to the kind of input data; b per 1 kilobyte as to the size of input data; and C1 as to the high importance of input data, respectively, as shown in FIG. 9. Therefore, the total input charge point (α1) will be α1=A2+2000b+C1. In this respect, the kind of input data and the size of input data are those parameters which are output by the automatic recognition of the document input unit, such as the scanner 204. However, the importance of the input data is recognized in accordance with the designated operational signals inputted by the user when he performs the designated operation, and then, the importance thereof is output as a charge parameter.

Now, subsequently, it is determined whether or not the document processing which should be executed by the document processing unit 104 is designated by the user (step S304). If affirmative, the document processing unit executes the document processing as designated, and then, the charge parameter which corresponds to the process thus executed, that is, the parameters as to the layout analysis process, the OCR process, the database processing, the compression process, and the encoding process as shown in FIG. 9, and the amount of data thus processed are output to the charge processing unit 105 (step S305).

Then, the charge processing unit 105 retrieves on the charge point setting table T the charge point information inputted from the document processing unit 104 corresponding to the charge point processing parameters. In accordance with the amount of processing data on the input of the charge point information thus retrieved, the charge points are calculated per processing, and the total value is calculated as the processed charge point to be output to the charge integration unit 111 (step S306).

For example, the layout information is analyzed by the layout analyzing process. Then, by use of the OCR, the character recognition process is performed, and the database processing is executed on the basis of such recognition with respect to the text code data and the image data which have not been prepared as text. In this case, it is assumed that the object of the layout analyzing process is a “one page”, and the result of the character recognition is “1,500 characters”, and that the target data of the database processing after the character recognition process is “60,000 bytes” including the layout information. In accordance with this example, it is assumed that the charge points of the layout analyzing process are x per one page as shown in FIG. 9. Therefore, it is 1x points. The charge point of the OCR process is y per 100 characters. Therefore, it is 15y points. The charge point of the database processing is z per 100 bytes. Therefore, it is 60z points. Ultimately, the total processed charge point (β1) is β1=1x+15Y+60z.

Here, in the step S304, if any document processing is not designated for execution, the process will proceed to step S306 without performing any document processing. In this case, none of charge process parameters or the like is output from the document processing unit 104. Therefore, the total processed charge point (β1), which is calculated in the charge point processing unit 105, will be “0”.

Subsequently, the document output unit 106 performs the document output process and outputs the charge output processing parameters to the charge output unit 107 corresponding to the output process thus executed. In other words, as shown in FIG. 9, these parameters are: the output process by means of the network; the output process to the external storage device; the output process by means of the facsimile; and the output process by means of the printer, among some other, and the amount of output data as well (step S307).

Then, the charge output unit 107 retrieves on the charge point setting table T the charge point information corresponding to the charge output parameters inputted from the document output unit 106. Then, in accordance with the charge point information thus retrieved and the amount of output data thus inputted, the value of the charge output points are calculated and output to the charge integration unit 111 (step S308).

Now, for example, as the output destination, the file server 206 is designated. Then, if the size of the output target data is “6 kilobytes”, the charge output points are n per 1 kilobytes. Therefore, the charge output points (γ1) is γ=6n.

Then, the charge integration unit 111 calculates the charge integrated points (step S309) which is a total of the charge input points, the charge processing points, as well as the charge output points obtained from the charge input unit 103, the charge processing unit 105, and the charge output unit 107. After that, the current process is finished.

In accordance with the example described above, the total charge points (σ1) is the sum of the charge input points (α1), the charge process points (β1), and the charge output points (γ1). The total charge points (σ1) is a σ1+β1+γ1, that is, [(A2+2000b+C1)+(1x+15y+60z)+(6n)].

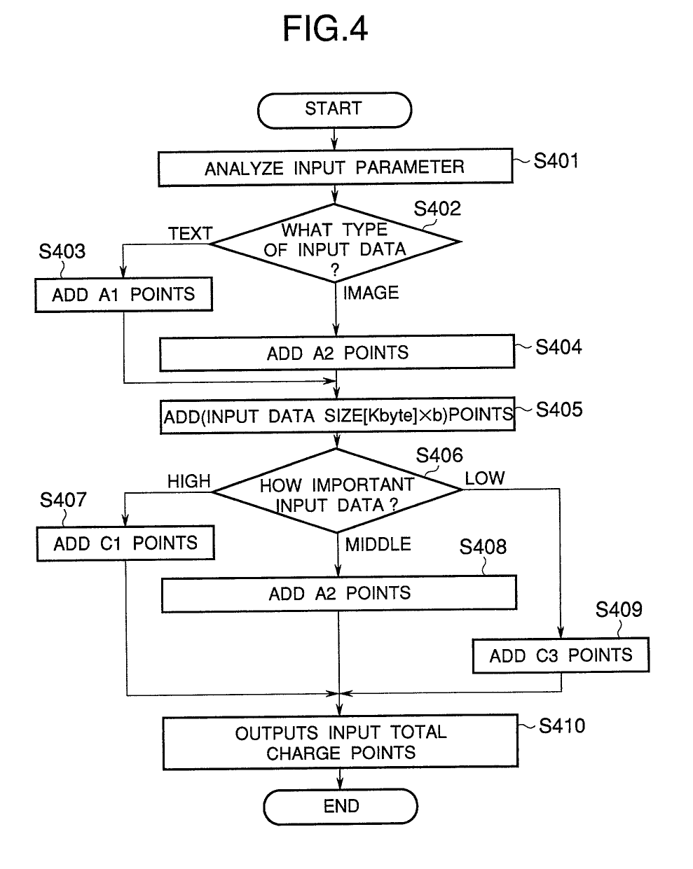

Now, the detailed description will be made of the charge input point calculation process in the step S303 in FIG. 3 in accordance with the flowchart shown in FIG. 4.

The charge input unit 103 analyzes the charge input parameters received from the document input unit 102 (step S401) to determine the kind of input data (step S402). As a result, if the kind of the input data is text, the A1 which is the charge point corresponding thereto is added to the input counter (step S403). If the kind of the input data is an image, the A2 which the charge point corresponding thereto is added to the input counter (step S404).

Then, the charge points of the data size received from the document input unit 102 are calculated, and added by use of the input counter (step S405). The charge points of the input data size is b per 1 kilobyte as shown in FIG. 9. Therefore, if, for example, the size of the input data is “50 kilobytes”, “50b” points are added by use of the input counter.

Subsequently, it is determined whether or not the importance of the input data is “high”, “middle”, or “low” (step S406). If it is “high”, the C1 which is the charge point corresponding thereto is added by use of the input counter (step S407). If it is “middle”, the C2 which is the charge point corresponding thereto is added by use of the input counter (step S408). If it is “low”, the C3 which is the charge point corresponding thereto is added by use of the input counter (step S409). Thus, the current value of the input counter is output to the charge integration unit 111 as the added value of the input charge points. The input counter is reset (step S410) to finish the current process.

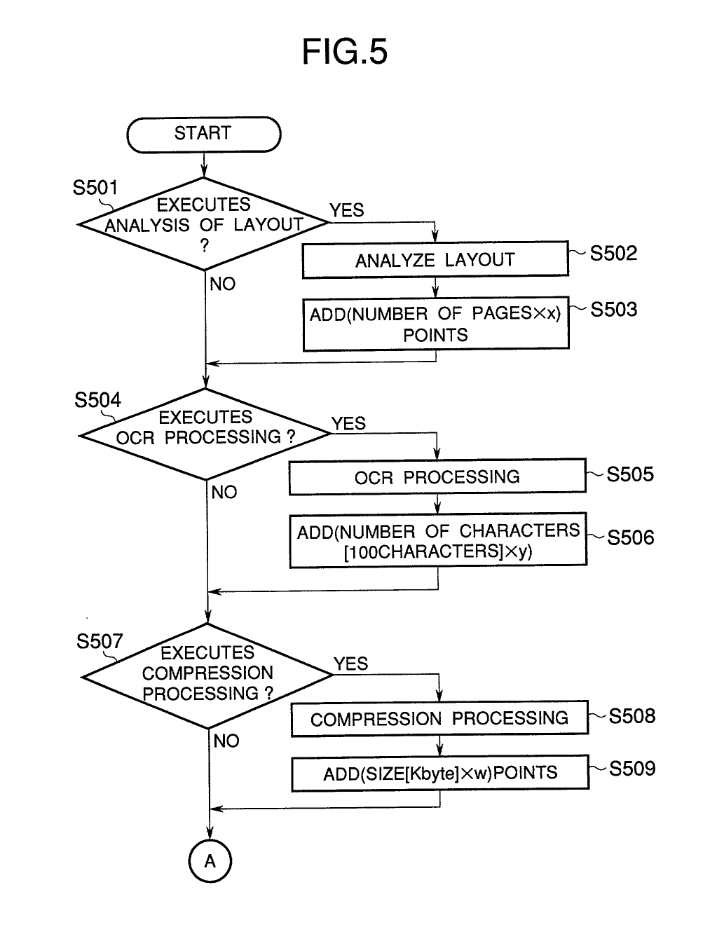

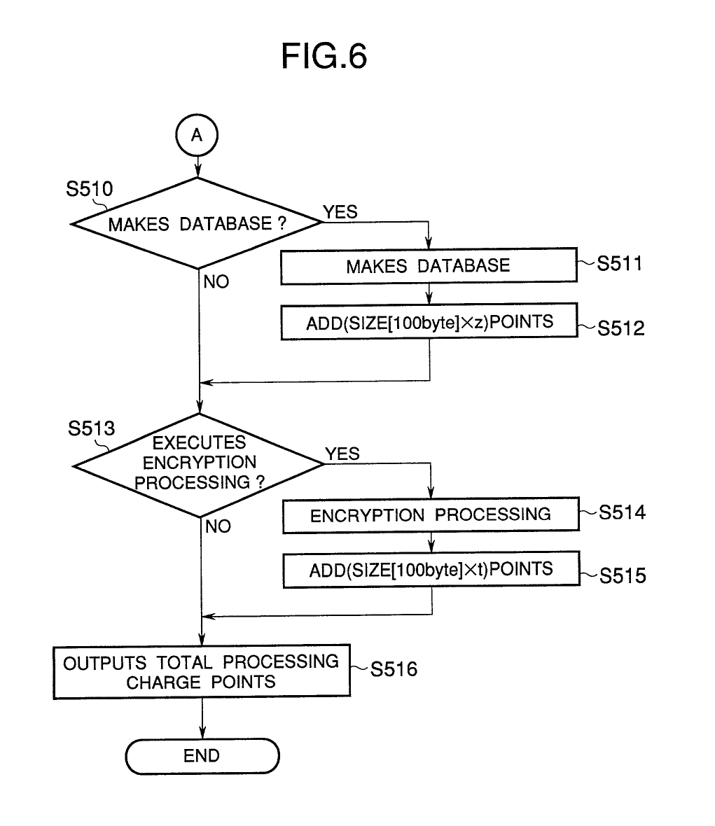

Now, the detailed description will be made of the calculation process of the charge point processing in the steps S304 to S306 in FIG. 3 in accordance with the flowcharts shown in FIGS. 5 and 6.

The document processing unit 104 determines whether or not the execution of layout analysis is designated (step S501). If affirmative, this unit executes the layout analyzing process as designated (step S502). Then, the charge processing unit 105 calculates the charge points of the layout analyzing process in accordance with the contents of the layout analyzing process thus executed (step S503). The process will then proceed to step S504. As shown in FIG. 9, the charge points of the layout analyzing process are x per one page. For example, therefore, the charge points of an 8-page layout analyzing process is 8x. On the other hand, if no layout analyzing process is designated, the process proceeds to step S504 skipping over the processes in the steps S502 and S503.

In the step S504, the document processing unit 104 determines whether or not the OCR analyzing process is designated. If affirmative, the OCR process is executed as designated (step S505). Then, the charge processing unit 105 calculates the charge points of the OCR process in accordance with the contents of the OCR process thus executed, which is added by use of the processing counter (step S506). The process proceeds to step S507. As shown in FIG. 9, the charge points of the OCR process are y per 100 characters. For example, therefore, the charge point of a 1,500-character recognition is 15y. On the other hand, if no OCR process is designated, the process proceeds to step S507 skipping over the processes in the steps S505 and S506.

In the step S507, the document processing unit 104 determines whether or not the compression process is designated. If affirmative, the compression process is executed as designated (step S508). Then, the charge processing unit 105 calculates the charge points of the depression process in accordance with the contents of the depression process thus executed, which is added by use of the processing counter (step S509). The process proceeds to step S510. As shown in FIG. 9, the charge points of the compression process are w per 1 kilobyte. For example, therefore, the charge point of a 60 kilobyte depression is 60w. On the other hand, if no compression process is designated, the process proceeds to step S510 skipping over the processes in the steps S508 and S509.

In the step S510, the document processing unit 104 determines whether or not the database processing is designated. If affirmative, the database processing is executed as designated (step S511). Then, the charge processing unit 105 calculates the charge points of the database processing in accordance with the contents of the database processing thus executed, which is added by use of the processing counter (step S512). The process proceeds to step S513. As shown in FIG. 9, the charge points of the database processing are z per 100-byte characters. For example, therefore, the charge point of a 6000-byte database processing is 60z. On the other hand, if no database processing is designated, the process proceeds to step S513 skipping over the processes in the steps S511 and S512.

In the step S513, the document processing unit 104 determines whether or not the encoding process is designated. If affirmative, the encoding process is executed as designated (step S514). Then, the charge processing unit 105 calculates the charge points of the encoding process in accordance with the contents of the encoding process thus executed, which is added by use of the processing counter (step S515). The process proceeds to step S516. As shown in FIG. 9, the charge points of the encoding process are t per 100 bytes. For example, therefore, the charge point of a 3000-byte data encoding is 30t. On the other hand, if no encoding process is designated, the process proceeds to step S516 skipping over the processes in the steps S514 and S515.

In the step S516, the current value of the processing counter is output to the charge integration unit 111 as the added value of the charge processing points. The processing counter is reset to finish the current process.

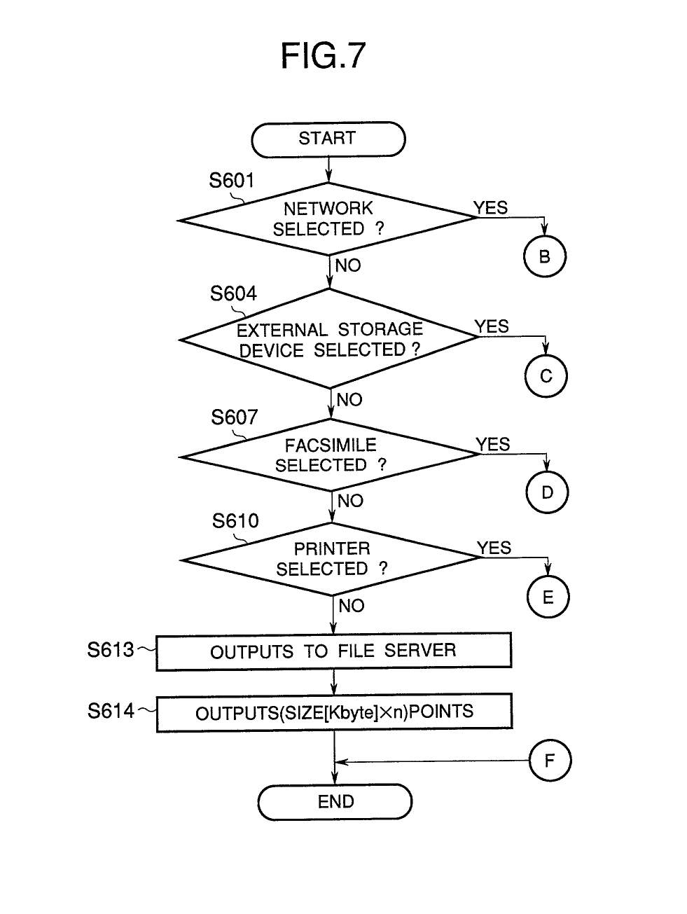

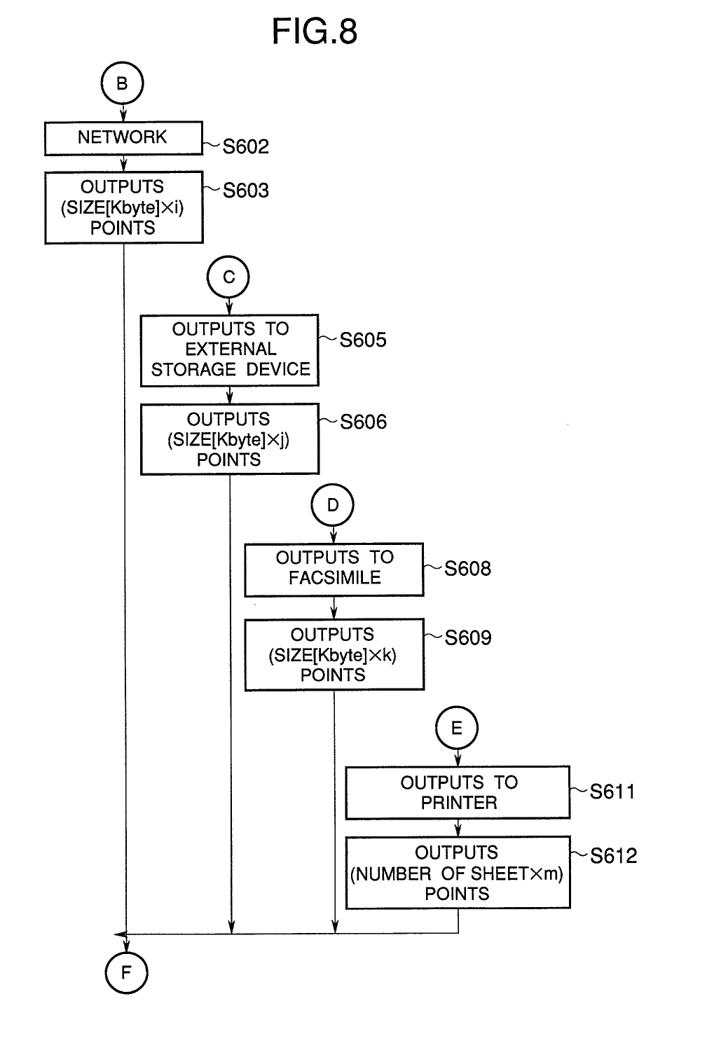

Now, the detailed description will be made of the charge output point calculation process in the steps S307 and S308 in FIG. 3 in accordance with the flowcharts shown in FIGS. 7 and 8.

The document processing unit 106 determines whether or not the network has been selected as the destination of the document output (step S601). If affirmative, the output to the network is executed (step S602). Then, the charge output unit 107 calculates the charge output points corresponding to the contents of the output process, and outputs them to the charge integration unit 111 (step S603). Thus, the current process is finished. As shown in FIG. 9, the charge points of the network output process are i per 100 bytes. For example, therefore, the charge output points are 40i when a 4,000-byte data is output to the network as the electronic mail.

On the other hand, if the network is not selected as the output destination, the document processing unit determines whether or not an external storage device is selected as the destination of the document output (step S604). If affirmative, the output to the external storage device is executed (step S605). Then, the charge output unit 107 calculates the charge output points corresponding to the contents of the output process, and outputs them to the charge integration unit 111 (step S606). Thus, the current process is finished. As shown in FIG. 9, the charge points of the output process to the external storage device are j per 1 kilobytes. For example, therefore, the charge output points are 2,000j when a 2,000-kilobyte data is output to the external storage device.

On the other hand, if no external storage device is selected as the output destination, the document processing unit determines whether or not a facsimile is selected as the destination of the document output (step S607). If affirmative, the output to the facsimile is executed (step S608). Then, the charge output unit 107 calculates the charge output points corresponding to the contents of the output process, and outputs them to the charge integration unit 111 (step S609). Thus, the current process is finished. As shown in FIG. 9, the charge points of the output process to the facsimile are k per 1 kilobytes. For example, therefore, the charge output points are 2,500k when a 2,500-kilobyte data is output to the facsimile.

On the other hand, if no facsimile is selected as the output destination, the document processing unit determines whether or not a printer is selected as the destination of the document output (step S610). If affirmative, the output to the printer is executed (step S611). Then, the charge output unit 107 calculates the charge output points corresponding to the contents of the output process, and outputs them to the charge integration unit 111 (step S612). Thus, the current process is finished. As shown in FIG. 9, the charge points of the output process to the printer are m per one page. For example, therefore, the charge output points are 10m when 10 pages are printed out.

On the other hand, if no printer is selected as the output destination, the output to the file server is executed (step S613). Then, the charge output unit 107 calculates the charge output points corresponding to the contents of the output process, and outputs them to the charge integration unit 111 (step S614). Thus, the current process is finished. As shown in FIG. 9, the charge points of the output process to the file server are n per 1 kilobyte. For example, therefore, the charge output points are 5n when a 5-kilobyte data is output to the file server.

In this respect, as presumable for the fact that the input counter and the processing counter are reset as described above, the charge input unit 103, the charge processing unit 105, the charge output unit 107, and the charge integration unit 111 are arranged to execute the charging process by a series of the data input and output and the processing thereof as a unit, respectively. Now, for example, a documental image is inputted into the computer 201 from the scanner 204, and the character recognition is executed by use of the OCR, and then, the database processing is executed with respect to the text code data obtained from the character recognition thus executed, and the image data which have not been prepared as text. The data thus processed are output to the file server 206.

As described above, in accordance with the present embodiment, fees are made chargeable separately by the input process, the analyzing and other processing, and the output process corresponding to a series of input and output processes, and the processing between them, and the contents of the input process, the analyzing and other processing, and the output process are subdivided. Hence, the fees are made chargeable by specifying the charge rates in accordance with the contents of processes thus subdivided and executed. Further, the charge integration process is performed to integrate the charging processes which are subdivided for the separate executions, respectively. In this way, it becomes possible to perform the minute and rational charging process in accordance with the rational charging control and management, and the contents of services rendered. Also, the charging processes are performed with a series of the data input and output, and the processing between them as unit, making it possible to utilize such unit as source materials to make fees chargeable to each user separately.

In this respect, the present invention is not necessarily limited to the embodiment described above. It may be possible to adopt the other units than those point calculation units shown in FIG. 9. For example, the charge points of the input process may be set for an image data by subdividing the charge unit in accordance with the resolution, the color information, or the like or it may be possible to set the charge points by combining the text and image together. Also, for example, it may be possible to set the point calculation unit of the layout analyzing process based upon the data size unit or the degree of layout complication, or the like, not necessarily to adopt the unit per page for the intended purpose.

Also, it is not necessarily to subdivide minutely the contents of the input process, the output process, and the processing between them each individually, but these processes and processing may be simply classified into three, and three pieces of charging information are registered accordingly. Then, on the basis of such charging information thus registered, the required charging process may be performed for the integration thereof. Here, it is also possible to omit the integration process.

As has been described above, in accordance with the above embodiments, it becomes possible for the charging apparatus that performs the charging process in consideration of the use of the data processing apparatuses connected to the network to make fees chargeable minutely and rationally in accordance with the contents of service rendered, because there are provided registration means for registering charging information per content of process executed by the aforesaid data processing apparatuses; determination means for determining the content of process executed by the aforesaid data processing devices and apparatuses; and charge processing means for performing charging process in accordance with the charging information corresponding to the content of process determined by the aforesaid determination means.

Also, it is extremely easy to modify the amount of chargeable fees by the modification of such points that have been described above.

What is claimed is:

1. A charging apparatus for apparatuses related to data processing connected with the network, comprising:
registration means for registering the charge information separately in accordance with the contents of processes executed by said apparatuses related to data processing;
determination means for determining a series of processed contents executed by said apparatuses related to data processing; and
charge processing means for performing charging process in accordance with said charge information corresponding to the series of processed contents determined by said determination means.

2. A charging apparatus according to claim 1, wherein said apparatus related to data processing are a versatile computer, a scanner, a printer, a copying machine, a display device, a file server, a facsimile equipment, an external storage device, and others.

3. A charging apparatus according to claim 1, wherein said registration means registers three pieces of charging information corresponding to the three kinds of processed contents of the data input process, the data processing, and the data output process, and said charging process means performs charging processes separately in accordance with said three kinds of processed contents, at the same time, performing the charge integration process to integrate the results of charging processes in accordance with said separate processes.

4. A charging apparatus according to claim 3, wherein said registration means registers the charge information separately in accordance with the subdivided contents of input data process, data processing, and output data process, and said charging process means performs charging process separately in accordance with said input, processing, and output processes corresponding to the content of input data process, the content of data processing, and the content of output data process, at the same time, performing the charge integration process to integrate the results of the charging processes per said separate process.

5. A charging apparatus according to claim 4, wherein the content of said input data process is classified into the kinds, the amounts, the degrees of importance, and others with respect to the input data.

6. A charging apparatus according to claim 5, wherein said kinds of input data are classified into text data, image data, and others.

7. A charging apparatus according to claim 6, wherein said image data is classified by resolution, monochrome, and color.

8. A charging apparatus according to claim 4, wherein the contents of said data processing are classified into layout analyzing process, character recognition process, database processing, compression process, encoding process, and others.

9. A charging apparatus according to claim 4, wherein the contents of said output data process are classified into network, external storage device, facsimile equipment, file server, display device, output process to a speaker, and others.

10. A charging apparatus according to claim 9, wherein the contents of said output data process are subdivided into the sizes of paper sheet, the quality of paper, and others when output to said printer.

11. A charging method for performing charging process with respect to the apparatuses related to data processing connected with the network, comprising the following steps of:
registering the charge information separately in accordance with the contents of processes executed by said apparatuses related to data processing;
determining a series of processed contents executed by said apparatuses related to data processing; and
performing charging process in accordance with said charge information corresponding to the series of processed contents determined by said determining step.

12. A charging method according to claim 11, wherein said apparatus related to data processing are a versatile computer, a scanner, a printer, a copying machine, a display device, a file server, a facsimile equipment, an external storage device, and others.

13. A charging method according to claim 11, wherein three pieces of charging information are registered in said registering step corresponding to the three kinds of processed contents of the data input process, the data processing, and the data output process, and charging processes are performed in said step of charging process separately in accordance with said three kinds of processed contents, at the same time, the charge integration process being performed to integrate the results of charging processes in accordance with said separate processes.

14. A charging method according to claim 13, wherein the charge information is registered in said registering step separately in accordance with the subdivided contents of input data process, data processing, and output data process, and charging process is preformed in said step of charging process separately in accordance with said input, processing, and output processes corresponding to the content of input data process, the content of data processing, and the content of output data process, at the same time, the charge integration process being performed to integrate the results of the charging processes per said separate process.

15. A charging method according to claim 14, wherein the content of said input data process is classified into the kinds, the amounts, the degrees of importance, and others with respect to the input data.

16. A charging method according to claim 15, wherein said kinds of input data are classified into text data, image data, and others.

17. A charging method according to claim 16, wherein said image data is classified by resolution, monochrome, and color.

18. A charging method according to claim 14, wherein the contents of said data processing are classified into layout analyzing process, character recognition process, database processing, compression process, encoding process, and others.

19. A charging method according to claim 14, wherein the contents of said output data process are classified into network, external storage device, facsimile equipment, file server, display device, output process to a speaker, and others.

20. A charging method according to claim 19, wherein the contents of said output data process are subdivided into the sizes of paper sheet, the quality of paper, and others when output to said printer.

21. A storage medium storing program for performing charging process with respect to the apparatuses related to data processing connected with the network, comprising the following routines of:
registering the charge information separately in accordance with the contents of processes executed by said apparatuses related to data processing;
determining a series of processed contents executed by said apparatuses related to data processing; and
performing charging process in accordance with said charge information corresponding to the series of processed contents determined by said determination routine.

22. A storage medium according to claim 21, wherein said apparatus related to data processing are a versatile computer, a scanner, a printer, a copying machine, a display device, a file server, a facsimile equipment, an external storage device, and others.

23. A storage medium according to claim 21, wherein three pieces of charging information are registered in said registering routine corresponding to the three kinds of processed contents of the data input process, the data processing, and the data output process, and charging processes are performed in said charging process routine separately in accordance with said three kinds of processed contents, at the same time, the charge integration process being performed to integrate the results of charging processes in accordance with said separate processes.

24. A storage medium according to claim 23, wherein the charge information is registered in said registering routine separately in accordance with the subdivided contents of input data process, data processing, and output data process, and charging process is preformed in said charging process routine separately in accordance with said input, processing, and output processes corresponding to the content of input data process, the content of data processing, and the content of output data process, at the same time, the charge integration process being performed to integrate the results of the charging processes per said separate process.

25. A storage medium according to claim 24, wherein the content of said input data process is classified into the kinds, the amounts, the degrees of importance, and others with respect to the input data.

26. A storage medium according to claim 25, wherein said kinds of input data are classified into text data, image data, and others.

27. A storage medium according to claim 26, wherein said image data is classified by resolution, monochrome, and color.

28. A storage medium according to claim 24, wherein the contents of said data processing are classified into layout analyzing process, character recognition process, database processing, compression process, encoding process, and others.

29. A storage medium according to claim 24, wherein the contents of said output data process are classified into network, external storage device, facsimile equipment, file server, display device, output process to a speaker, and others.

30. A storage medium according to claim 29, wherein the contents of said output data process are subdivided into the sizes of paper sheet, the quality of paper, and others when output to said printer.
